(19) United States
(12) Patent Application Publication
(10) Pub. No.: US 2013/0036044 A1
(43) Pub. Date: Feb. 7, 2013

(54) COMMUNICATION DEVICE FOR CONTACTING A BUSINESS

(71) Applicant: Richard Ball Steward, Mesa, AZ (US)

(72) Inventor: Richard Ball Steward, Mesa, AZ (US)

(21) Appl. No.: 13/566,316

(22) Filed: Aug. 3, 2012

Related U.S. Application Data
(60) Provisional application No. 61/515,265, filed on Aug. 4, 2011.

(51) Int. Cl. G06Q 20/32; H04W 4/00; H04B 7/26

(52) U.S. Cl. 705/39; 455/39; 455/507; 455/41.2

(57) ABSTRACT

A communication device for contacting a business is provided. The device can be a stand-alone communication device that is capable of connecting to a business over a wireless network. The device includes a microphone, a speaker, a single control to activate the device, and contact information related to a business. Once activated, the device utilizes the contact information and connects to the business to facilitate communication between the business and a consumer who activates the device. The speaker and microphone allow the user to communicate and relay information through the communication device. The device may further contain a means to collect payment information and transmit that information to the business entity for automatic billing.

### CROSS REFERENCE TO RELATED APPLICATION[S]

This application claims priority to U.S. Provisional patent application to Steward entitled “COMMUNICATION DEVICE FOR CONTACTING A BUSINESS,” Ser. No. 61/515,265, filed Aug. 4, 2011, the disclosure of which is hereby incorporated entirely herein by reference.

### BACKGROUND

1. Technical Field

This disclosure relates generally to communication devices, and, in particular, to a device that facilitates communication between a place of business and a customer of the business.

2. State of the Art

The communication industry is an integral part of an individual's daily life. The communication industry is responsible for transferring information, such as letters, Morse code or telephone conversations, from one location to another. From the inception of the pony express to the telegraph and the telephone, daily communication continues to become more sophisticated, streamlined and efficient.

As the forms of transferring information have become more sophisticated, the methods for distributing and storing contact information have been slow to follow. The standard business card has evolved through the ages, beginning initially with trade cards in 17^{th} century London and moving to the conventional business card of today. The largest problem with business cards is that they are easily lost or ruined. For businesses to effectively share their contact information with potential customers, they need an efficient means of sharing their contact information that customers will keep long-term and utilize over and over.

A business that cannot effectively connect with its customers will inevitably suffer. For example, when a customer needs to contact a business for any reason, they first have to obtain the contact information related to that business. A conventional business card is a viable means of obtaining the contact information. But, oftentimes, the business card that has been given to the customer by the business has been lost, misplaced, or is otherwise not immediately convenient. This may lead to frustration by the customer and communication between the business and the customer could stop there, resulting in loss of potential revenue to the business. If, on the other hand, the customer has not lost the business card, or ruined it as the case may be, the customer must then scan the business card to locate the appropriate contact information and ensure that it is for the location that he/she intends to contact. Then the customer must locate a telephone and dial the number for the business. All of these cumulative steps may lead to added frustration, excessive use of the customer's time, incorrectly dialed numbers, and/or the wrong business being contacted.

In view of the above, there is a need in the communication industry for businesses to be able to effectively share contact information with customers, in a sophisticated way that will allow the customers to efficiently connect with the desired businesses.

### SUMMARY

The present disclosure relates to a stand-alone communication device, and, in particular, to a business card that adheres to a surface, displays contact information of a business or other entity, activates upon operation of a control, and uses wireless technology to communicate with the business.

An aspect of the present disclosure includes a communication device comprising a housing, identification information of a business entity on the housing, and a control on the housing, wherein operation of the control places a user of the device in communication with the business entity.

Another aspect of the present disclosure includes the communication device further comprising communication means for connecting the communication device to a wireless network to place the user in communication with the business entity, wherein the communication means is configured to permit the communication device to contact only the business entity on the housing.

Another aspect of the present disclosure includes the communication means connecting the communication device to the business entity via a wireless network established by a cellular tower.

Another aspect of the present disclosure includes the communication means connecting the communication device to the business entity via a wireless network established by a wireless router connected to a wired internet connection.

Another aspect of the present disclosure includes the communication means further comprising short-range data exchange technology that wirelessly connects the communication device to a user's wireless enabled device, such that the communication means connects the communication device to the business entity via the user's wireless enabled device.

Another aspect of the present disclosure includes the communication device further comprising payment means for submitting payment to the business entity for an order placed by the user through the communication device.

Another aspect of the present disclosure includes the payment means comprising a magnetic strip reader that is configured to read a magnetic strip of a credit, debit, prepaid card, or gift card.

Another aspect of the present disclosure includes the payment means comprising a RFID system having a RFID reader embedded in the device and configured to communicate with corresponding RFID tags coupled to one or more user's wireless enabled devices.

Another aspect of the present disclosure includes the communication device, wherein the RFID tag is programmed with the user's physical address and payment information, such that under the condition that the user places the wireless enabled device in functional proximity with the communication device to activate the RFID system, payment for the order is automatically submitted to the business entity using the payment information and the order is automatically scheduled for delivery to the physical address.

Another aspect of the present disclosure includes coupling means for releasably coupling the device to a surface, wherein the identification information and the coupling means are configured on opposing sides of the housing.

Another aspect of the present disclosure includes the control being a single push-button control positioned on a surface of the housing also containing the identification information of the business entity.

Another aspect of the present disclosure includes the control comprising a plurality of push-buttons that must be operated concurrently to activate the device.

Another aspect of the present disclosure includes a communication device comprising a housing having a first side and a second side, contact information of a business entity on the first side of the housing, a control on the first side of the housing, a speaker, a microphone, communication means for connecting the communication device to a wireless network to place the user in communication with the business entity, wherein the communication means is configured to permit the communication device to establish communication only with the business entity on the housing, payment means for submitting payment to the business entity for an order placed by the user through the communication device, and coupling means for releasably coupling the device to a surface, the coupling means being positioned on the second side of the housing, wherein operation of the control activates the communication means to place a user of the device in communication with the business entity.

Another aspect of the present disclosure includes the communication means connecting the communication device to the business entity via a wireless network established by a cellular tower or via a wireless network established by a wireless router connected to a wired internet connection.

Another aspect of the present disclosure includes the communication means further comprising short-range data exchange technology that wirelessly connects the communication device to a user's wireless enabled device, such that the communication means connects the communication device to the business entity via the user's wireless enabled device.

Another aspect of the present disclosure includes the payment means comprising a RFID system having a RFID reader embedded in the device and configured to communicate with corresponding RFID tags coupled to one or more user's wireless enabled devices.

Another aspect of the present disclosure includes the RFID tag being programmed with the user's physical address and payment information, such that under the condition that the user places the wireless enabled device in functional proximity with the communication device to activate the RFID system, payment for the order is automatically submitted to the business entity using the payment information and the order is automatically scheduled for delivery to the physical address.

Another aspect of the present disclosure includes a method of communicating with a business entity, the method comprising providing a communication device that is configured to connect to a wireless network, displaying identification information of the business entity on the communication device, assigning a contact information number to the communication device that corresponds to the business entity, providing a single control on the communication device that operates the communication device, and connecting the communication device to the business via the wireless network upon operation of the single control.

Another aspect of the present disclosure includes placing an order for goods or services with the business via the communication device, and paying for the goods and services via the communication device, including transmitting payment information via the communication device, wherein paying for the goods or services further comprises providing the communication device having a RFID reader therein, providing a RFID tag, associating the RFID tag with a user, programming the RFID tag with a user's contact information and payment information, coupling the RFID tag to the user's wireless enabled device, bringing the user's wireless enabled device having the RFID tag therein in proximity to the communication device, powering the RFID tag by proximity to the RFID reader, transmitting a signal from the RFID reader to the RFID tag, receiving a signal from the RFID tag, the signal containing the contact information and the payment information, and transmitting the contact information and the payment information via the wireless network to the business.

Another aspect of the present disclosure includes placing an order for goods or services with the business via the communication device, and paying for the goods and services via the communication device, including transmitting payment information via the communication device, wherein paying for the goods or services further comprises swiping the magnetic strip on a credit card, debit card, prepaid debit card, gift card, etc. through a card reader on the device, reading the magnetic strip by the card reader, and transmitting the information on the magnetic strip to the business via the wireless network.

The foregoing and other features and advantages of the present disclosure will be apparent from the following more detailed description of the particular embodiments of the disclosure, as illustrated in the accompanying drawings.

### BRIEF DESCRIPTION OF THE DRAWINGS

FIG. 1 is a front view of an embodiment of a communication device in accordance with the present disclosure.

FIG. 2 is a rear view of the communication device of FIG. 1.

FIG. 3 is a front perspective view of the communication device of FIG. 1.

FIG. 4 is a side view of the communication device of FIG. 1.

FIG. 5 is a front view of an embodiment of a communication device in accordance with the present disclosure.

FIG. 6 is a rear view of the communication device of FIG. 5.

FIG. 7 is a front perspective view of the communication device of FIG. 5.

FIG. 8 is a side view of the communication device of FIG. 5.

FIG. 9 is a front view of an embodiment of a communication device in accordance with the present disclosure.

FIG. 10 is a rear view of the communication device of FIG. 9.

FIG. 11 is a front perspective view of the communication device of FIG. 9.

FIG. 12 is a side view of the communication device of FIG. 9.

FIG. 13 is a schematic view of the communication device in accordance with the present disclosure.

FIG. 14 is a schematic view of the communication device in accordance with the present disclosure.

FIG. 15 is a schematic view of the communication device in accordance with the present disclosure.

FIG. 16 is a schematic view of the communication device in accordance with the present disclosure.

FIG. 17 is a schematic view of the communication device in accordance with the present disclosure.

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

As discussed above, embodiments of the present disclosure relate to a stand-alone communication device, and, in particular, to a communication device that may adhere to a surface, displays contact information of a business or other entity thereon, activates by operation of a control positioned on the device, and utilizes wireless technology to communicate with said business or entity.

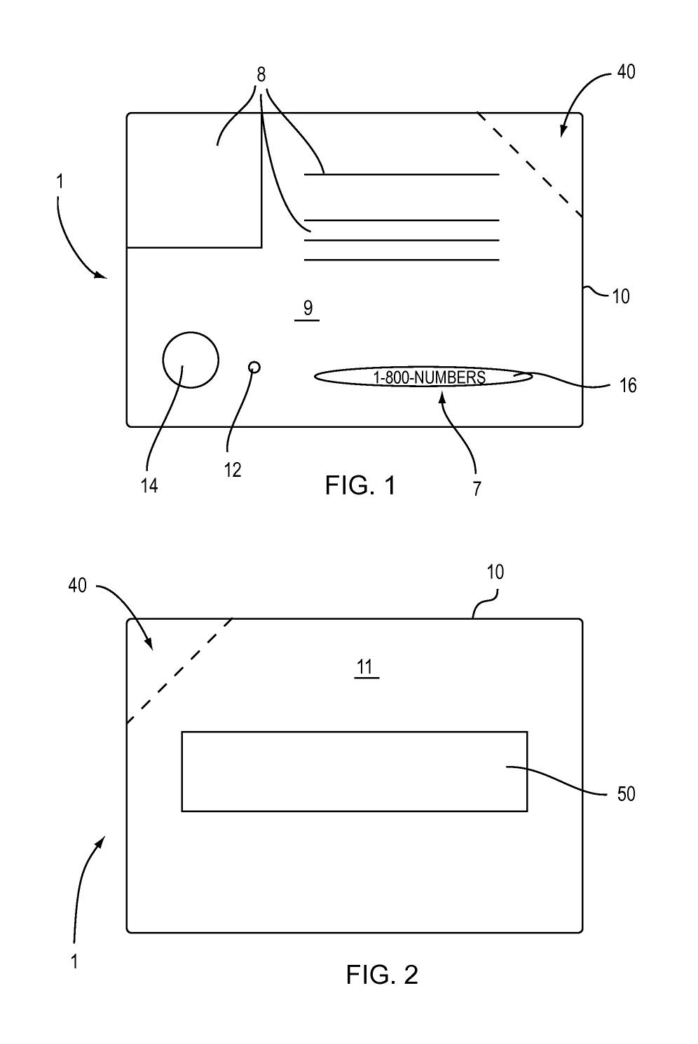

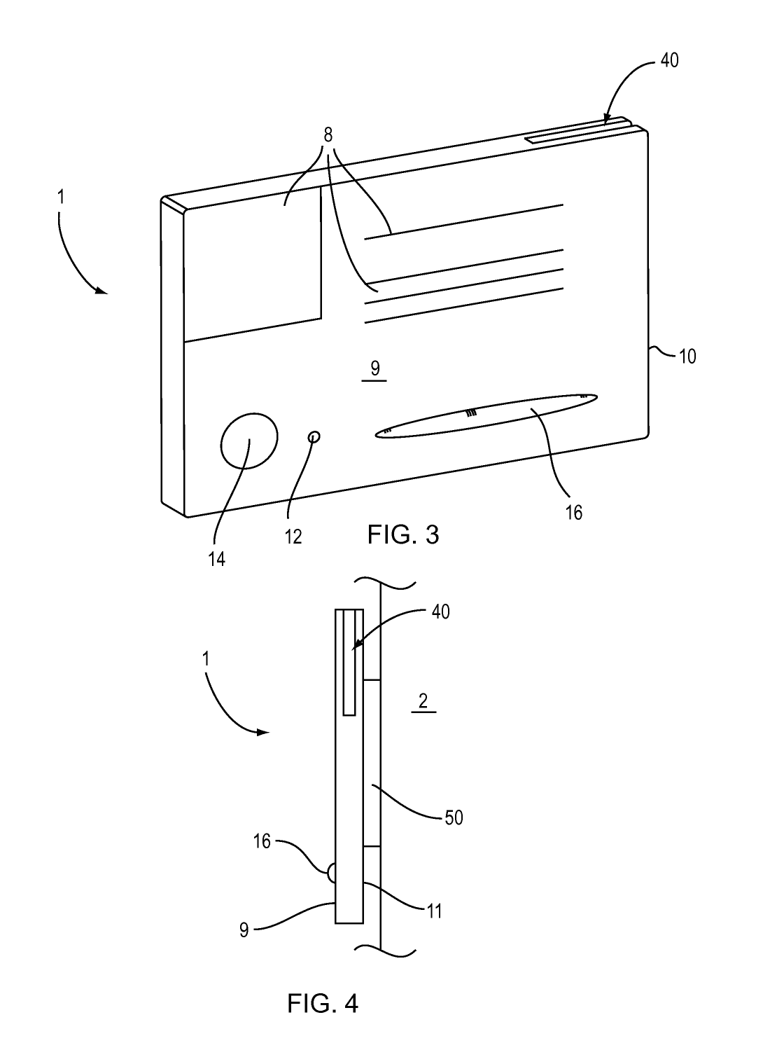

As depicted in FIGS. 1-4, a stand-alone communication device 1 may comprise contact information 8, a housing 10, a microphone 12, a speaker 14, a control 16, a battery 18, a communication means 30 for placing the device 1 in communication with a network or other communication device, for example, connecting the device 1 to either a wireless network or a wireless communication device. The device 1 may further comprise a payment means 40 for collecting payment information or making payment and coupling means 50 for adhering, or otherwise coupling, the device 1 to a surface 2.

Embodiments of the communication device 1 may comprise a housing 10 that defines the structural dimensions, i.e., the shape and size of the device 1. For example, the housing 10 may be rectangular-shaped. A thin rectangular shape may allow the device 1 to be configured to conveniently fit into the billfold of a wallet or a purse carried by a customer/user. A generally rectangular-shape further allows the device 1 to display the contact information 8 of a business entity 12 on a first side 9 of the housing 10 and to repeatedly and releasably adhere to a surface 2 by the coupling means 50 positioned on a second side 11 of the housing 10.

Alternatively, the device 1 may be circular in shape, such that the device 1 does not have sharp or otherwise harsh edges and may be carried in a pocket of an article of clothing worn by a user without the device 1 jabbing or digging into the user. A circular shape further allows the device 1 to display the contact information 8 of a business on the first side 9 of the housing 10 and to adhere to a surface 2 by the coupling means 50 positioned on the second side 11 of the housing 10.

The housing 10 may take additional shapes and forms, so long as the housing 10 comprises at least a first side 9 and a second side 11, such that the device 1 may display the contact information 8 of a business entity 12 on the first side 9 of the housing 10 so as to be viewable by the user/customer and may rest on, adhere to, or otherwise be supported by a surface 2 by the coupling means 50 positioned on the second side 11 of the housing 10.

In embodiments of the device 1, the first side 9 and second side 11 of the housing 10 may be positioned on opposing sides of the housing 10. In additional embodiments of the device 1, the first side 9 and second side 11 of the housing 10 may be positioned on adjacent sides of the housing 10, such as in an exemplary configuration where the housing 10 is shaped in a cube-like form or a triangular-like form. In such embodiments, the cube-like or triangular-like shaped housing 10 may rest on or be adhered to a horizontal surface on the second side 11, i.e., a bottom side of the housing 10, may display the contact information 8 of a business, or other retail entity, on the sides of the housing 10, and in the case of the cube-shaped housing 10 may have positioned thereon the control 16 on the top surface of the cube-like shaped housing 10 for easy activation by the user/customer.

Embodiments of the communication device 1 may comprise coupling means 50. The coupling means 50 may comprise for example, but not limited to, a magnet for adhering to metal surfaces, a hook-and-loop fastener, adhesive tape, adhesive glues, adhesive stickers, or other means of releasably and repeatedly adhering the device 1 to a surface 2. The coupling means 50 may be coupled to a side of the device 1 that does not contain the contact information 8, so that under the condition that the coupling means 50 adheres the device 1 to a surface 2, the contact information 8 is not covered, or obscured from view, but remains exposed and visible to a user/customer that intends to, or otherwise would have need to, operate the device 1. Embodiments of the device 1 may comprise the coupling means 50 being concealed within the housing 10, such that the coupling means 50 is positioned within the housing 10. In this configuration, the coupling means 50 could be a strong magnet that adheres the device 1 to metal surfaces through the second side 11. Embodiments of the device 1 may comprise the coupling means 50 being flush with the second side 11 of the device 1 or may comprise the coupling means 50 protruding from the second side 11, as shown in FIG. 4.

Embodiments of the communication device 1 may comprise contact information 8 related to an entity displayed on the device 1. The contact information 8 may be displayed on the first side 9 of the housing 10, such that the contact information 8 is readily viewable by a user/customer from wide viewing angles. The contact information 8 may be information related to the entity, such as, for example, the physical location of the entity, days and hours of operation, manager's names, telephone numbers, facsimile numbers, email addresses, trademarks used to identify the entity, other identifying indicia, one or more website addresses, and the like. Portions of the contact information 8, for example, a telephone number 7 may be displayed on a control 16.

Embodiments of the device 1 may include a control 16. The control 16 may comprise a means for activating the communication device 1. The control 16 may be a single push-button control located on the housing 10 of the device 1, wherein pushing the button activates the device 1, or the control 16 may comprise a full front side panel of the housing 10 of the device 1, wherein pushing the side panel of the housing 10 activates the device 1. The control 16 may further comprise a means for displaying at least a portion of the contact information 8 thereon. The means for displaying at least a portion of the contact information 8 includes the device 1 being configured to display the business contact information 8 comprising at least a telephone number 7 to the user/customer. The telephone number 7 may be displayed in a number of ways, for example, but not limited to, being printed on the control 16 itself, which is positioned on the first side 9 of the device 1, as depicted in FIG. 1. Also, the telephone number 7 can being affixed to the first side 9 of the device 1 near the control 16. Also, the control 16 itself may formed into the shape of the numbers that comprise the telephone number 7, such that the control 16 is displayed as the telephone number 7 of the business entity 12 associated with the telephone number 7 programmed into the device. Configuring the device 1 to display the telephone number 7 on, near, or as, the control 16 allows the customer/user to quickly and readily associate the number 7 with the business entity 12 associated with the device 1.

Embodiments of the device 1 include the user being able to simply press the telephone number 7 on the control 16 of the device 1, which pressing of the telephone number 7 activates the control 16. Embodiments of the device include the control 16 being configured to be illuminated at all times to assist the user in finding and locating the control 16. The control 16 may also be configured to illuminate when activated by the user and turn off when not in use, or after a predetermined amount of time has passed.

In embodiments of the device 1 where the telephone number 7 forms part of, or is placed on the control 16, the telephone number 7 may be configured to be illuminated at all times to assist the user in finding and locating the telephone number 7. The telephone number 7 may also be configured to illuminate when activated by the user and turn off when not in use, or after a predetermined amount of time has passed. Additionally, the control 16 can be configured to be illuminated in a first color and the telephone number 7 can be configured to be illuminated in a second color. Embodiments of the device 1 include the telephone number 7 or the control 16 illuminating in a third color when the battery 18 is low in charge.

Further, embodiments of the device 1 can include the control 16, or the telephone number 7, being configured to be illuminated in intermittent flashes, such that the control 16 and/or the telephone number 7 blinks to indicate status states of the device 1. Thus, in embodiments of the device 1, the telephone number 7 or control 16 can be illuminated when not in use and then, once activated by the user, blink to indicate that the device 1 is in use. The rate of blinking can also be configured to indicate the status of the device 1. For example, the rate of blinking when the device 1 is attempting to connect to the business entity 12 can be slower or faster than the rate of blinking when the device is connected to the business entity 12. The rate of blinking when the battery 18 of the device is low can be faster or slower than the rate of blinking of other states of the device 1.

Further, embodiments of the device 1 can include the device 1 being configured to output audible sounds to indicate various status states of the device 1. Specifically, the device 1 may be configured to output a preconfigured number of beeps to indicate a corresponding status state. For example, the device 1 may be configured to beep once when the control 16, or telephone number 7, is activated. The device 1 may be configured to beep twice when the device 1 attempts to connect to the business entity 12 associated with the device but fails to make the connection for whatever reason. The device 1 may beep three times to indicate a busy signal from the business entity 12. The device 1 may intermittently beep to indicate that the battery 18 is low on charge. The device 1 may beep 4 times to indicate a malfunctioning device 1, such as, for example, when activation of the control 16 directs the device 1 to find and dial the pre-stored telephone number 7 but fails to find the pre-stored telephone number 7. Embodiments of the device 1 can include the device 1 being configured to output these audible sounds in addition to, or in conjunction with, the blinking configuration described above.

As mentioned above, the control 16 comprises means for activating the device 1. To activate, or otherwise operate, the device 1, the user simply locates the telephone number 7 displayed on the device 1 or displayed near, or as the control 16, and operates the control 16, which operation activates the device 1 and commands the device 1 to contact, connect, and otherwise communicate with the business entity 12 whose contact information 8 is displayed on the device 1 and is associated with the device 1. Specifically, by operating the control 16, the device 1 dials the telephone number 7 listed on the device, the telephone number 7 being the contact number associated with the business entity 12 and the contact information 8 displayed on the device 1. The business entity 12 answers, whether manually or automatically, the dialed call and establishes communication with the device 1, such that the user/customer of the device 1 may at least verbally and auditorily communicate with the business entity 12 or with a representative of the business entity 12 through the device 1. The user may communicate with the business entity 12 using the microphone 12 and the speaker 14. For example, the user may speak into the microphone 12 and the device 1 may convert the verbal signals acquired via the microphone 12 into data and transfer the data along the established connection while, on the other hand, the speaker 14 broadcasts to the user the auditory sounds converted by the device 1 from the data received from the business entity 12 transferred along the established connection.

Embodiments of the device 1 may include the device 1 being configured to store and dial a single telephone number 7. The device 1 may be programmed to store the single telephone number 7. The device 1 may further be configured to be able to be re-programmed to store a different single telephone number 7 than the telephone number 7 originally stored on the device 1, such that the original telephone number 7 is removed and replaced by a new telephone number 7. Thereafter, the device 1 dials the new telephone number 7 once the control 16 is activated. The telephone number 7 may be the number corresponding to an individual retail store. Alternatively, the telephone number 7 may be the number corresponding to a directory assistance network of a company having many retail stores located at various locations across a geographic region, such that by dialing the directory assistance network of the company, the network can redirect and connect the user to the company's retail store located closest to the user.

Embodiments of the device 1 may include the device 1 being configured to have a transparent housing 10, such that a conventional business card can be inserted within the housing 10 and the contact information 8 on the inserted business card can be visible to the user through the housing 10. In such embodiments, the device 1 may be programmed to dial the telephone number 7 on the conventional business card placed within the housing 10, such that the device 1 is associated with the business entity 12 that is described, or otherwise indicated, on the conventional business card within the housing 10.

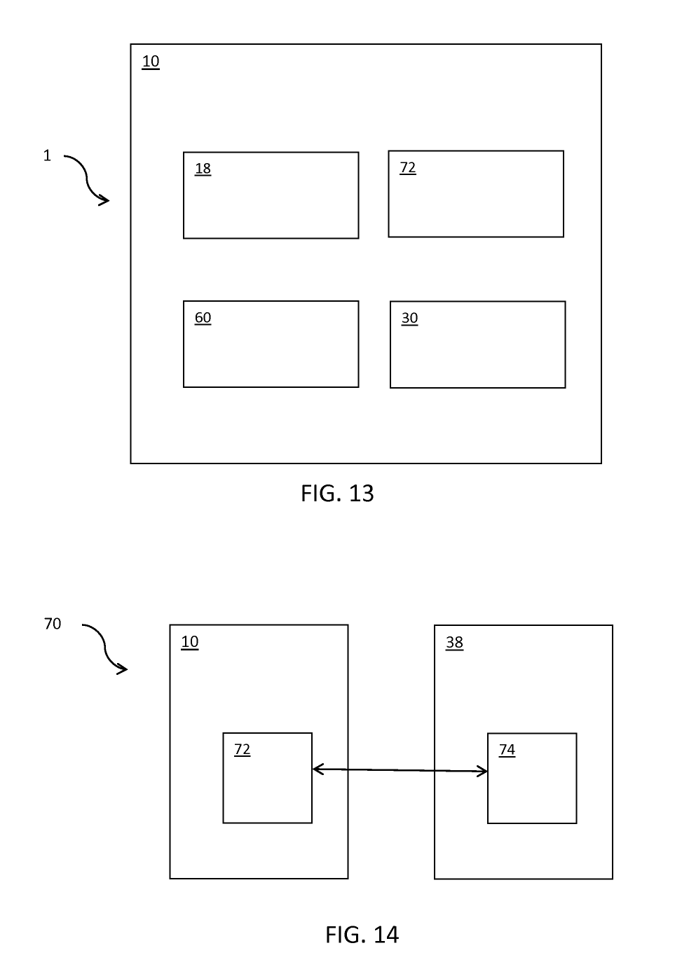

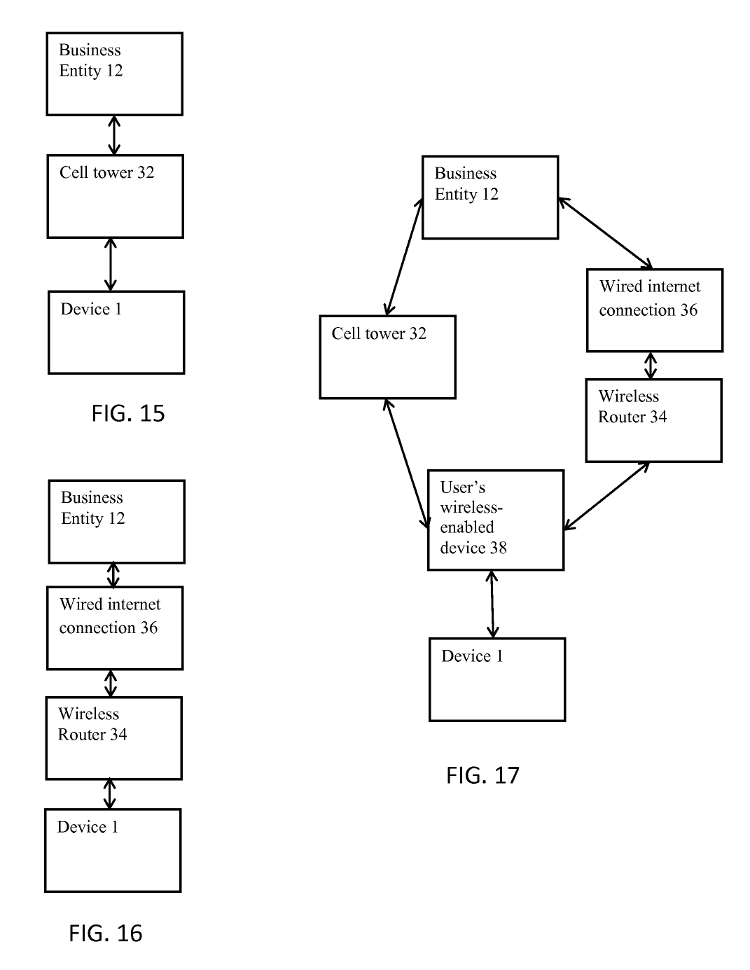

Referring now to FIGS. 13-16, embodiments of the communication device 1 may comprise a communication means 30 for establishing the connection between the device 1 and the business entity 12 associated with the contact information 8 displayed on the device 1. The communication means 30 may also be configured to conduct the operations of the device 1, such as drawing power from the battery 18, storing the telephone number 7, directing the illumination of the control 16 or the audible status indicator sounds, and other necessary operations. The communication means 30 may be positioned within the housing 10 of the device, as shown in FIG. 13. The communication means 30 may further comprise components that allow the device 1 to connect to and transmit data and signals over a wireless network. The components of the communication means 30 may include, but are not limited to, a circuit board, an antenna, a processor, a memory, an operating system, an analog-to-digital converter, a digital-to-analog converter, an RF component, a SIM card, a digital signal processor (DSP), and an RF amplifier. Operating the control 16 activates the communication means 30 to establish the communicative connection over the wireless network between the device 1 and the business entity 12 associated with the contact information 8 on the device 1. The communication means 30 may further comprise components that allow the device 1 to connect to the internet, whether via a cellular tower 32 provided by a cellular telephone company, as depicted in FIG. 15, or via a wireless router 34 connected to a wired internet connection 36 from an internet service provider, as depicted in FIG. 16. The communication means 30 may permit the device 1 to transfer data between the retail provider, or business entity 12, and the user via the internet.

The communication means 30 may further comprise components that allow the device 1 to connect to and transmit data and signals between another wireless device that is capable of transmitting data over a wireless network, such as by utilizing Bluetooth® technology, or other short-distance, data-exchange technology. The components may include, but are not limited to, short-range transceivers that send and receive low-power radio waves within the ISM radio-frequency band to facilitate transmission of data between the communication means 30 and the other wireless devices, such as a user's smartphone or wireless enabled device 38. Operating the control 16 activates the communication means 30 to establish the communicative connection between the device 1 and the user's wireless enabled device 38, such that the user of the device 1 can communicate with the business entity 12 associated with the contact information 8 on the device 1, by way of the device 1 communicating with the user's wireless enabled device 38, and the user's wireless enabled device 38 communicating with the business entity 12 associated with the contact information 8 on the device 1 over the wireless network to which the user's wireless enabled device 38 is connected, either via the cell tower 32 or wireless router 34, as applicable to the capabilities of the particular user's wireless enabled device 38, as depicted in FIG. 17.

Embodiments of the communication device 1 may comprise a payment means 40 for making, or otherwise submitting, a payment for services or products purchased by way of the device 1 from the business to which the device 1 is associated. The payment means 40 may comprise a magnetic strip reader for reading the magnetic strip of a user's magnetically encoded credit, debit, gift card, pre-paid card, or the like. The information read from the user's card by the payment means 40 may then be transmitted by the device 1 via the internet to the business entity 12 associated with the device 1, such that payment from the customer is submitted to and received by the business entity 12. Embodiments of the communication device 1 may further comprise the payment means 40 having pre-stored user-specific account information associated specifically with the device 1 such that under the condition that the user operates the device 1 to purchase goods and services from the business entity 12 associated with the device 1, the user thereby authorizes the business entity 12 to charge the user's account associated with the user's specific device 1, or the business entity 12 may automatically charge the user's account associated with the user's specific device 1.

Embodiments of the communication device 1 may further comprise the payment means 40 having a QR code displayed on the device 1 that is scanable by the user's smartphone or other wireless-enabled device 38. The QR code may include instructions for submitting payment or means for submitting payment to the business entity 12 associated with the device 1 using the user's smartphone or other wireless-enabled device 38 that are enabled to read the QR code.

Embodiments of the communication device 1 may further comprise the communication device having radio frequency (RF) induction capability and radio frequency identification (RFID) capability. In addition to, or in the alternative of, the magnetic card reader, the payment means 40 may comprise an RFID system 70 that uses a interrogator/reader 72 to send a signal to a RFID tag 74 embedded in, or otherwise coupled to, a user's smartphone or other wireless-enabled device 38, as depicted in FIG. 14. The reader 72 may be run by software stored on the device 1 and may be powered by the battery 18. The reader 72 may include a two-way radio transmitter/receiver that sends a signal to a RFID tag 74 on a user's smartphone or other wireless-enabled device 38 and likewise reads the response from the RFID tag 74. The RFID tag 74 may also include a small RF transmitter and receiver. The RFID tag 74 can be either passive, active or battery assisted passive. The active tag has an on-board battery and periodically transmits its ID signal. The battery assisted passive (BAP) has a small battery on board and is activated when in the presence of the RFID reader 72. The passive tag is cheaper and smaller because it has no battery. Instead, the passive tag 74 uses the radio energy transmitted by the reader 72 as its energy source. The reader 72 must be close for the RF field to be strong enough to transfer sufficient power to the passive tag 74. In operation, the reader 72 transmits an encoded radio signal to interrogate the RFID tag 74. The RFID tag 74 receives the message and responds with identification information previously assigned to or associated with the RFID tag 74. Since RFID tags 74 may have individual serial numbers assigned thereto, the payment means 40, specifically the RFID system 70, of the device 1 can discriminate several RFID tags 74 that might be within the range of the RFID reader 72 and read them simultaneously.

The business 12 may provide individual customers with the RFID system 70. The device 1 may include the RFID reader 72 and the business entity 12 may provide to the user a RFID tag 74 to place on or in the customer's smartphone or wireless enabled device 38, as shown in FIG. 14. This RFID tag 74 may be preprogrammed with a customer's contact information, such as for example and not limiting in any sense, a physical address, and payment information, such as, for example and not limiting in any sense, credit card information or bank account information. In this way, the RFID tag 74 provided to the customer can be programmed with the customer's payment and contact information, such that the user may use the RFID tag 74 to order and pay for products and services ordered via the device 1. Specifically, the customer may order goods and services by operating the control 16 of the device 1 and thereafter swipe their personal wireless device having the RFID tag 74 coupled thereto near the RFID reader 72 embedded, or otherwise coupled to, the device 1 to activate the RFID system 70 and pay for the good and services ordered. The RFID reader 72 communicates with the RFID tag 74, gathers the information on the RFID tag 74, and transmits this information to the business via the communication means 30 and the associated wireless network. The business can then receive the information, process the order, process the payment information, and deliver the goods and/or services to the customer at the physical address. The processing fo the payment information may be performed automatically upon activation of the RFID system 70. Moreover, the delivery of the goods and/or services may be automatically scheduled upon activation of the RFID system 70 may be delivered once the goods and/or services are ready for delivery/performance.

Embodiments of the communication device 1 may further comprise a biometric reader 60 such as a fingerprint reader, for restricting use of the device 1 to an individual user authorized to use the device 1. Specifically, the biometric reader 60 may be programmed by the user to restrict use of the device 1 to the user, or other users, that are authorized by the biometric reader 60 to use the device 1. Further, the communication device 1 may further comprise the biometric reader 60 functioning as the control 16, such that upon the condition that the user places his/her finger on the biometric reader 60 and the biometric reader 60 accepts a preprogrammed fingerprint to permit access to the communication device 1 the communication device 1 connects to the business associated with the communication device 1 and allows the user to communicate with the business, as described herein.

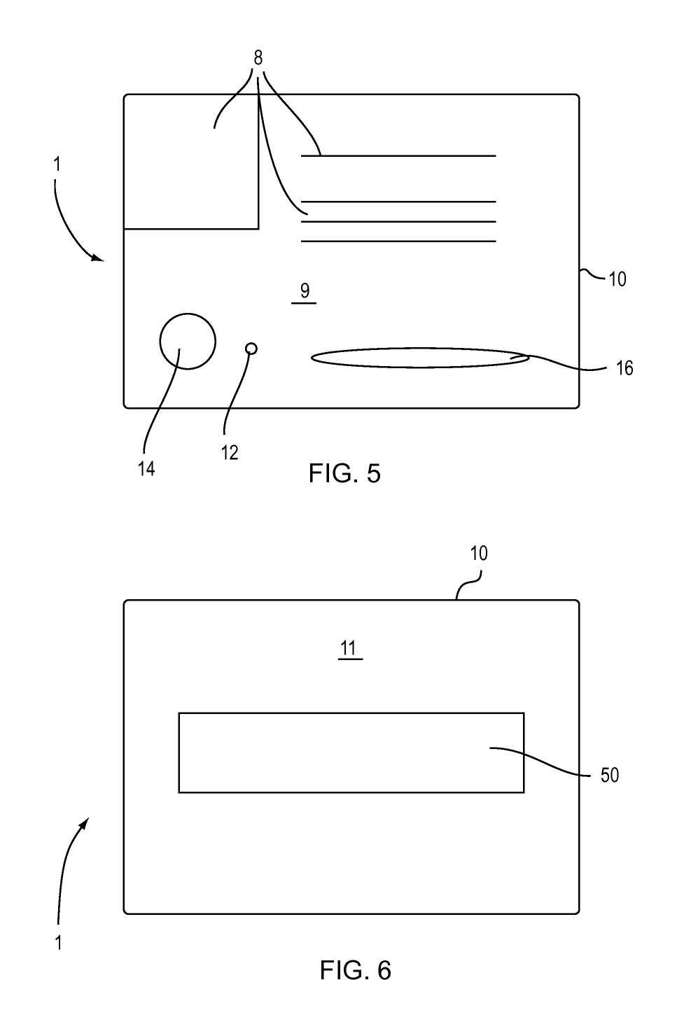

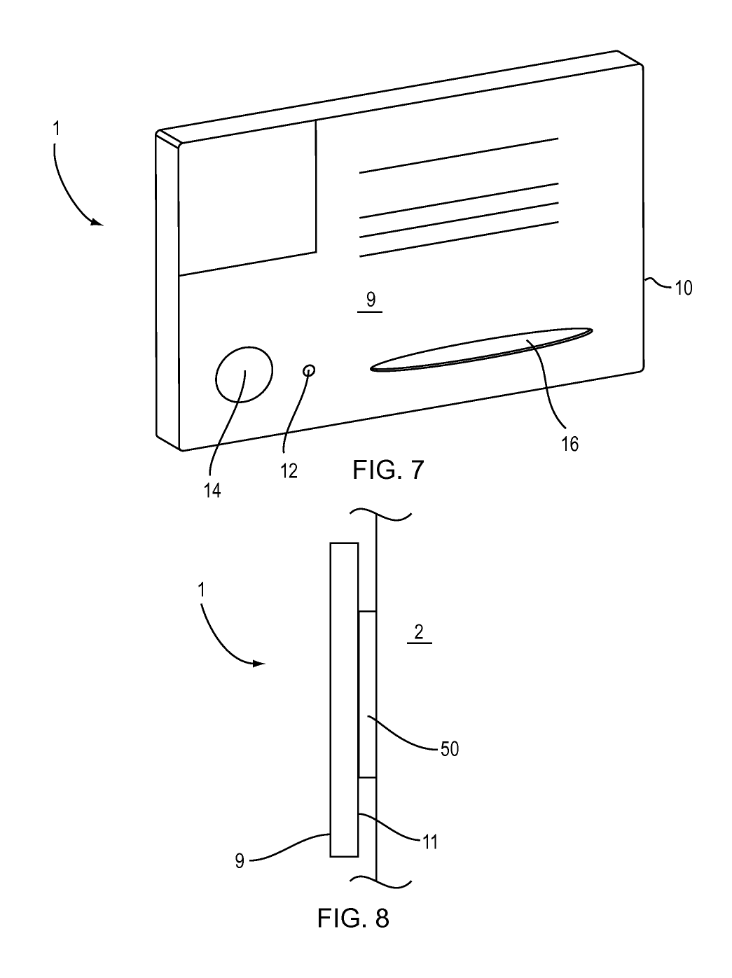

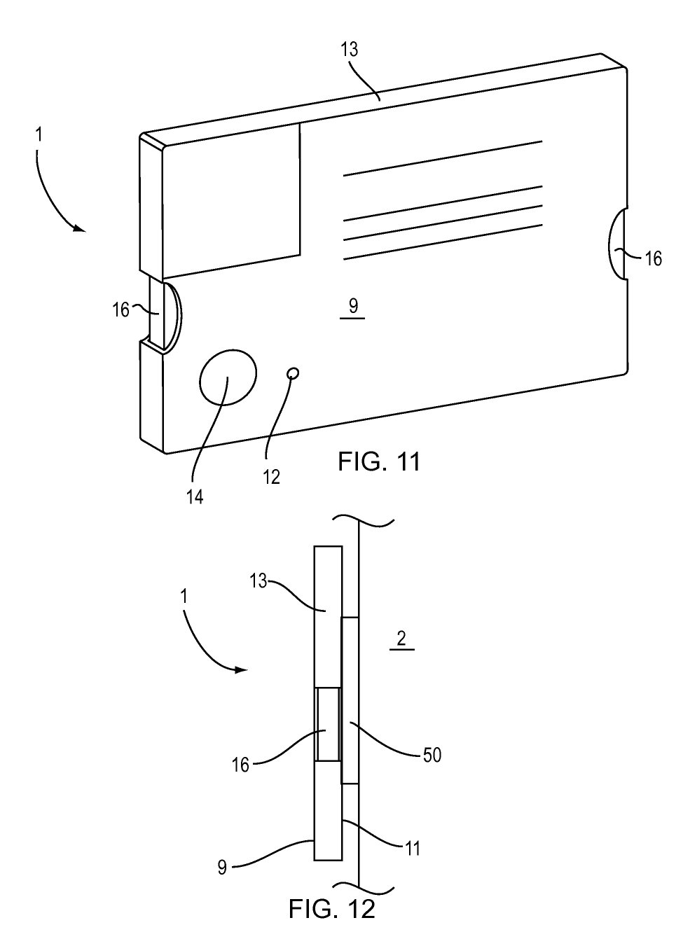

As depicted in FIGS. 1-12, embodiments of the device 1 may include a control 16. As depicted in FIGS. 1-4, the device 1 may include a control 16 that protrudes from the first side 9 of the device 1. The protruding control 16 may facilitate easier operation of the control 16 by the user. Specifically, a protruding control 16 is easier to locate by touch, especially in cases where visibility is limited, such as in the dark, or at night. Alternatively, as depicted in FIGS. 5-8, the device 1 may include a control 16 that is recessed in the first face 9 of the device 1. A recessed control 16 prevents unwanted operation of the control 16 under the condition that the first side 9 of the device is pressed against another surface inadvertently. For example, with a recessed control 16, as depicted in FIG. 7, the device 1 may be placed in the billfold or pocket of a user and the control 16 is less likely to be inadvertently activated by the first side 9 brushing up against another surface in the billfold or pocket.

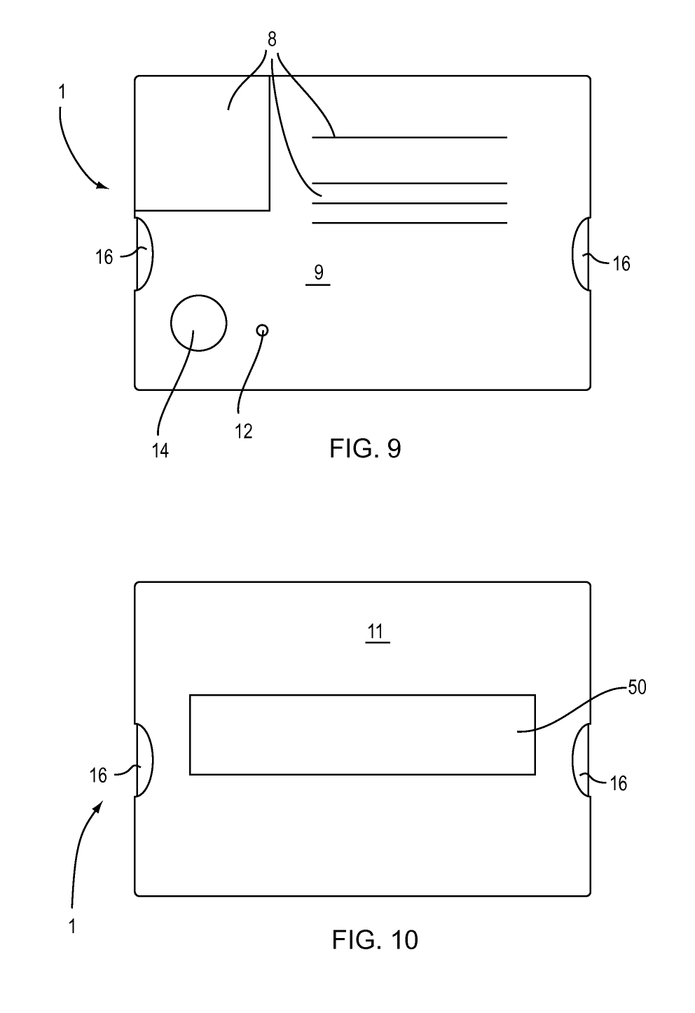

As depicted in FIGS. 9-12, the device 1 may include multiple controls 16 that may be positioned on the side edges 13 of the housing. The odds of the control 16 being inadvertently operated and activating the device 1 is minimized by the inclusion of multiple controls 16. Multiple controls 16 may help prevent inadvertent operation of the device 1 under the condition that the device 1 is, for example, placed in the purse, billfold or wallet of the user. For example, positioning the controls 16 on the side edges 13 of the housing 10 may prevent the activation of the device 1 caused by the larger sides of the device 1, namely the first and second sides 9 and 11, inadvertently brushing up against another surface or structure. Embodiments of the device 1 may further comprise a control 16 being placed on the first surface 9 and another control 16 being placed on the edge surface 13 to prevent inadvertent operation of the device 1. Embodiments of the device 1 may further comprise multiple controls 16 being placed on the first surface 9 and the edge surfaces 13. Each of these multiple controls 16 may be independently and separately configured and programmed to exhibit any or all of the illumination and blinking configurations described above.

The components defining the above-described device 1 may be formed of any of many different types of materials or combinations thereof that can readily be formed into shaped objects provided that the components selected are consistent with the intended operation of a communication device. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining the above-described device 1 may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

A method of using the wireless communication device is described herein. The method may include providing a communication device that is configured to connect to a wireless network, displaying contact information of a business on the communication device, assigning a contact information number to the communication device that corresponds to the business, providing a single control on the communication device that operates the communication device, connecting the communication device to the business via the wireless network upon operation of the single control. The method may further comprise connecting the communication device to a wireless network via communication with a wireless router. The method may further comprise connecting the communication device to a wireless network via communication with a cellular tower. The method may further comprise connecting the communication device to another wireless communication device via Bluetooth® technology, or other short-distance, data-exchange technology, the another wireless communication device being capable of connecting to a wireless network such that the communication device of the present disclosure is connected to the wireless network via the another wireless communication device.

The method may further comprise communicating with the business via the communication device, including receiving auditory input by way of the microphone on the device, converting auditory input into digital data, transmitting the digital data to the business over the wireless network, receiving digital data from the business over the wireless network, converting the digital data into auditory output, outputting the auditory output by way of the speaker on the device. The method may further comprise placing an order for goods and services with the business and paying for the goods and services via the communication device, including transmitting payment information via the communication device. The transmitting payment information via the communication device may include swiping the magnetic strip on a credit card, debit card, prepaid debit card, gift card, etc. through a card reader on the device, reading the magnetic strip by the card reader, transmitting the information on the magnetic strip to the business via the wireless network. The transmitting payment information via the communication device may include providing the communication device having a RFID reader therein, providing a RFID tag, associating the RFID tag with a user, programming the RFID tag with a user's contact information and payment information, coupling the RFID tag to the user's wireless enabled device 38, bringing the user's wireless enabled device 38 having the RFID tag therein close to the device, powering the RFID tag by proximity to the RFID reader, transmitting a signal from the RFID reader to the RFID tag, receiving a signal from the RFID tag, the signal containing the contact information and payment information, transmitting the contact information and the payment information via the wireless network to a business.

The method may further comprise assigning an identification number to the communication device, setting up a user account with the business to associate an individual user with an identified communication device, and assigning a user's payment information and physical address to the user account and to the communication device, activating the communication device by operating the single control to thereby place an order and pay for the order using the user's account associated with the identified communication device. The method may further comprise delivering the order to the physical address associated with the communication device.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. The claims provide the scope of the coverage of the present disclosure and should not be limited to the specific examples provided herein.

What is claimed is:

1. A communication device comprising:
a housing;
identification information of a business entity on the housing; and
a control on the housing,
wherein operation of the control places a user of the device in communication with the business entity.

2. The communication device of claim 1, further comprising:
communication means for connecting the communication device to a wireless network to place the user in communication with the business entity, wherein the communication means is configured to permit the communication device to contact only the business entity on the housing.

3. The communication device of claim 2, wherein the communication means connects the communication device to the business entity via a wireless network established by a cellular tower.

4. The communication device of claim 2, wherein the communication means connects the communication device to the business entity via a wireless network established by a wireless router connected to a wired internet connection.

5. The communication device of claim 2, wherein the communication means further comprise short-range data exchange technology that wirelessly connects the communication device to a user's wireless enabled device, such that the communication means connects the communication device to the business entity via the user's wireless enabled device.

6. The communication device of claim 1, further comprising:
payment means for submitting payment to the business entity for an order placed by the user through the communication device.

7. The communication device of claim 6, wherein the payment means comprises a magnetic strip reader that is configured to read a magnetic strip of a credit, debit, prepaid card, or gift card.

8. The communication device of claim 6, wherein the payment means comprises a RFID system having a RFID reader embedded in the device and configured to communicate with corresponding RFID tags coupled to one or more user's wireless enabled devices.

9. The communication device of claim 8, wherein the RFID tag is programmed with the user's physical address and payment information, such that under the condition that the user places the wireless enabled device in functional proximity with the communication device to activate the RFID system, payment for the order is automatically submitted to the business entity using the payment information and the order is automatically scheduled for delivery to the physical address.

10. The communication device of claim 1, further comprising:
coupling means for releasably coupling the device to a surface, wherein the identification information and the coupling means are configured on opposing sides of the housing.

11. The communication device of claim 1, wherein the control is a single push-button control positioned on a surface of the housing also containing the identification information of the business entity.

12. The communication device of claim 1, wherein the control comprises a plurality of push-buttons that must be operated concurrently to activate the device.

13. A communication device comprising:
a housing having a first side and a second side;
contact information of a business entity on the first side of the housing;
a control on the first side of the housing;
a speaker;
a microphone;
communication means for connecting the communication device to a wireless network to place the user in communication with the business entity, wherein the communication means is configured to permit the communication device to establish communication only with the business entity on the housing;
payment means for submitting payment to the business entity for an order placed by the user through the communication device; and
coupling means for releasably coupling the device to a surface, the coupling means being positioned on the second side of the housing,
wherein operation of the control activates the communication means to place a user of the device in communication with the business entity.

14. The communication device of claim 13, wherein the communication means connects the communication device to the business entity via a wireless network established by a cellular tower or via a wireless network established by a wireless router connected to a wired internet connection.

15. The communication device of claim 13, wherein the communication means further comprise short-range data exchange technology that wirelessly connects the communication device to a user's wireless enabled device, such that the communication means connects the communication device to the business entity via the user's wireless enabled device.

16. The communication device of claim 13, wherein the payment means comprises a RFID system having a RFID reader embedded in the device and configured to communicate with corresponding RFID tags coupled to one or more user's wireless enabled devices.

17. The communication device of claim 16, wherein the RFID tag is programmed with the user's physical address and payment information, such that under the condition that the user places the wireless enabled device in functional proximity with the communication device to activate the RFID system, payment for the order is automatically submitted to the business entity using the payment information and the order is automatically scheduled for delivery to the physical address.

18. A method of communicating with a business entity, the method comprising:
providing a communication device that is configured to connect to a wireless network;
displaying identification information of the business entity on the communication device;
assigning a contact information number to the communication device that corresponds to the business entity;
providing a single control on the communication device that operates the communication device; and
connecting the communication device to the business via the wireless network upon operation of the single control.

19. The method of claim 18, the method further comprising:
placing an order for goods or services with the business via the communication device; and
paying for the goods and services via the communication device, including transmitting payment information via the communication device, wherein paying for the goods or services further comprises:
providing the communication device having a RFID reader therein;
providing a RFID tag;
associating the RFID tag with a user;
programming the RFID tag with a user's contact information and payment information;
coupling the RFID tag to the user's wireless enabled device;
bringing the user's wireless enabled device having the RFID tag therein in proximity to the communication device;
powering the RFID tag by proximity to the RFID reader;
transmitting a signal from the RFID reader to the RFID tag;
receiving a signal from the RFID tag, the signal containing the contact information and the payment information;
transmitting the contact information and the payment information via the wireless network to the business.

20. The method of claim 18, the method further comprising:
placing an order for goods or services with the business via the communication device; and
paying for the goods and services via the communication device, including transmitting payment information via the communication device, wherein paying for the goods or services further comprises:
swiping the magnetic strip on a credit card, debit card, prepaid debit card, gift card, etc. through a card reader on the device;
reading the magnetic strip by the card reader; and
transmitting the information on the magnetic strip to the business via the wireless network.
